(19) United States
(12) Patent Application Publication
(10) Pub. No.: US 2004/0253568 A1
(43) Pub. Date: Dec. 16, 2004

(54) Method of improving reading of a text

(76) Inventor: Bonnie S. Shaver-Troup, San Jose, CA (US)

Correspondence Address: HICKMAN PALERMO TRUONG & BECKER, LLP, 1600 WILLOW STREET, SAN JOSE, CA, 95125, US

(21) Appl. No.: 10/462,865

(22) Filed: Jun. 16, 2003

(51) Int. Cl. G09B 17/00

(52) U.S. Cl. 434/178

(57) ABSTRACT

A method for improving reading of a text comprises receiving an individual reader profile; selecting, based on the profile, a set of text formatting criteria from stored sets of text formatting criteria; receiving a first text; and reformatting the first text, based on the selected text formatting criteria, to result in creating a second text, wherein the reformatting includes expanding spacing of characters within words of the first text. Reformatting may include expanding a character spacing characteristic of the first text by an amount selected from about 2 points to about 7 points; changing a font size of the first text to a font size selected from about 14 points to about 30 points; changing line spacing; changing character scaling; and changing a font type of the first text to a sans serif font. A reader experiences improved reading of the second text as compared to the first text.

### FIELD OF THE INVENTION

The present invention relates to methods of improving reading in humans. The invention relates more specifically to methods for improving reading of texts including books and other printed matter, electronic documents, and other texts. The invention also relates to methods of treating certain learning disabilities that are manifested by difficulty in reading, such as dyslexia.

### BACKGROUND OF THE INVENTION

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Humans are gifted with varying abilities to read and comprehend a written text in a book, other printed matter, or in electronic documents. Certain learning disorders, such as dyslexia, are manifested in part by difficulties in reading or comprehending written texts. Researchers and therapists in the fields of learning disorders and cognitive science have searched for years to identify therapeutic techniques that can enable children or adults with dyslexia and other reading problems to improve their ability to read and comprehend written texts, with various degrees of success.

Certain therapeutic techniques have sought to use computers to aid in evaluating and treating dyslexia and other reading problems. For example, G. W. Kamstrup et al., “Screen Design Aspects of Computer-Supported Reading,” an abstract submitted to WWDU 2002, The 6^{th} International Scientific Conference on Work With Display Units, describes a computer system that enables a learner to select text display characteristics that best enable the learner to read and comprehend a text. These characteristics include font type, font size, line length, line spacing, word spacing, foreground color, and background color. While this type of system may provide improvement in some learners, it has several deficiencies.

The principal problem with Kamstrup et al. is that it proposes to enable each learner to create an individual profile, but this is not especially helpful because learners may be unaware of particular combinations of text display characteristics that best enable the learners to read and comprehend a text. It would be better to have a system that more specifically defined the combination of characteristics that are used, to improve the likelihood that a particular learner would experience success with the system.

Further, Kamstrup et al. fails to account for all possible characteristics that are used by computer displays and computer printers to display or print text. In particular, Kamstrup et al. does not account for the potential effect on reading of the spacing of characters within words.

WYNN software, commercially available from Freedom Scientific Learning Systems Group, has similar deficiencies. For example, WYNN enables a reader to change font size, font type, line spacing, spacing between words, line length, and color, but does not account for the potential effect on reading of the spacing of characters within words.

### SUMMARY OF THE INVENTION

A method and apparatus for improving reading of a text involves the computer-implemented steps of receiving an individual reader profile; selecting, based on the individual reader profile, a set of text formatting criteria from among a plurality of stored sets of text formatting criteria; receiving a first text; and reformatting the first text, based on the selected set of text formatting criteria, to result in creating and storing a second text, wherein the reformatting includes expanding spacing of characters within words of the first text.

In one embodiment, reformatting the first text includes expanding a character spacing characteristic of the first text by a specified amount selected from a range of about 2 points to about 7 points; changing a font size of the first text to a specified font size selected from a range of about 14 points to about 30 points; and changing a font type of the first text to Avant Garde font.

According to one feature, the individual profile comprises a grade level value and a reading speed value. Each of the sets of text formatting criteria may comprise a character spacing value. In another feature, each of the sets of text formatting criteria comprises a character spacing value selected from a range of about 2 points expansion to about 7 points expansion. In another feature, each of the sets of text formatting criteria comprises a character spacing value and a font size value. In another feature, each of the sets of text formatting criteria comprises a character spacing value, and a font size value selected from a range of about 14 points to about 30 points.

In another feature, each of the sets of text formatting criteria comprises a character spacing value, a font size value, and a line spacing value. In another feature, each of the sets of text formatting criteria comprises a character spacing value, a font size value, a line spacing value, and a character scale value. In another feature, each of the sets of text formatting criteria comprises a character spacing value, a font size value, a line spacing value, and a character scale value selected from a range of about 100% to about 150%.

In another feature, each of the sets of text formatting criteria further comprises a font type value that specifies a sans-serif font. In another feature, each of the sets of text formatting criteria further comprises a font type value that specifies Avant Garde font.

In another feature, the reformatting step comprises expanding a character spacing characteristic of the first text by a specified amount. In another feature, the reformatting step comprises expanding a character spacing characteristic of the first text by a specified amount selected from a range of about 2 points to about 7 points. In another feature, the reformatting step comprises the steps of expanding a character spacing characteristic of the first text by a specified amount, and changing a font size of the first text to a specified font size. In another feature, the reformatting step comprises the steps of expanding a character spacing characteristic of the first text by a specified amount, and changing a font size of the first text to a specified font size selected from a range of about 14 points to about 30 points.

In another feature, the reformatting step comprises the steps of expanding a character spacing characteristic of the first text by a specified amount, changing a font size of the first text to a specified font size, and changing a line spacing of the first text to a specified line spacing. In another feature, the reformatting step comprises the steps of expanding a character spacing characteristic of the first text by a specified amount, changing a font size of the first text to a specified font size, changing a line spacing of the first text to a specified line spacing, and changing a character scale of the first text to a specified character scale. In another feature, the reformatting step further comprises changing a font type of the first text to a sans-serif font. In another feature, the reformatting step further comprises changing a font type of the first text to Avant Garde font.

According to another aspect of the invention, a method of improving reading of a text is provided. The method involves receiving an individual profile of a reader; selecting, based on the individual reader profile, a set of text formatting criteria from among a plurality of stored sets of text formatting criteria; receiving a first text; reformatting the first text, based on the selected set of text formatting criteria, to result in creating and storing a second text, including: expanding a character spacing characteristic of the first text by a specified amount selected from a range of about 2 points to about 7 points; changing a font size of the first text to a specified font size selected from a range of about 14 points to about 30 points; changing a font type of the first text to Avant Garde font; and providing the second text to the reader for reading, wherein the reader experiences improved reading of the second text as compared to the first text.

The invention also encompasses a computer-readable medium and computer apparatus configured for performing the foregoing steps.

### BRIEF DESCRIPTION OF THE DRAWINGS

The present invention is illustrated by way of example, and not by way of limitation, in the figures of the accompanying drawings and in which like reference numerals refer to similar elements and in which:

J FIG. 1 is a flow diagram of an example embodiment of a method of improving reading of a text;

FIG. 2A is a diagram of a first text;

FIG. 2B is a diagram of a second text comprising a copy of the first text in which intra-word character spacing is increased;

FIG. 2C is a diagram of a second text comprising a copy of the first text in which intra-word character spacing is increased, character scaling is increased, line spacing is changed, font type is changed, and font size is changed;

FIG. 3A is a diagram of a dialog box for selecting a font in a word processor;

FIG. 3B is a diagram of a dialog box for selecting character spacing and character scaling in a word processor;

FIG. 4A is a diagram of a screen display for selecting a text conversion tool;

FIG. 4B is a diagram of a screen display that is generated upon selecting a plain text conversion tool;

FIG. 4C is a diagram of a screen display of a question page;

FIG. 4D is a diagram of a file selection page;

FIG. 4E is a diagram of a text display page showing a second text;

FIG. 5 is a block diagram of a computer network with which an embodiment can be implemented; and

FIG. 6 is a block diagram of a computer system with which an embodiment may be implemented.

### DETAILED DESCRIPTION OF THE INVENTION

A method and apparatus for improving reading of a text is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein according to the following outline:

1. Method of Improving Reading of a Text

2. Implementation Example

2.1 Text Conversion Tool

2.2 Computer Network Arrangement

2.3 Example of Computer Hardware and Software Media

3. Extensions and Alternatives

1.0 Method of Improving the Readability of a Text

FIG. 1 is a flow diagram of a method of improving reading of a text. This section and FIG. 1 describe a method in its broadest sense. The method may be implemented in many different ways, including but not limited to implementation in a standalone software application, or in a software-based service that is delivered over a network such as the Internet. Example implementations are described in subsequent sections of this description.

In block 102, an individual reader profile is received. The reader profile comprises information that describes characteristics of a reader for purposes of determining how to reformat a text in a way that is likely to improve the ability of the reader to read or comprehend the text. For example, a reader profile may comprise information values indicating an educational grade level of the reader, a degree of difficulty that the reader experiences in reading, or both.

In block 104, a set of text formatting criteria is selected based on the individual reader profile. In one embodiment, a computer system stores a plurality of sets of text formatting criteria that are appropriate for readers having different reader profiles. Block 104 involves selecting one of the stored sets of text formatting criteria based on the reader profile that was obtained in block 102.

In one embodiment, each of the sets of text formatting criteria specifies a change in character spacing. For example, one set of text formatting criteria may specify expanding character spacing of a text by 6.2 points. In this context, the term “points” refers to the conventional measure of distance as used in the printing and electronic publishing fields. Additionally, a set of text formatting criteria may specify a change in font size, character scale, or line spacing. For example, one set of text formatting criteria may specify increasing font size to 26 point, changing character scale to 150%, and changing line spacing to double spacing.

“Font size” refers to the average height of a capital letter in the associated font. “Character scale” is a factor that determines the width of a character compared to a reference width; a character scale greater than 100% indicates that all characters appear wider horizontally when they are displayed or printed. “Line spacing” refers to distance among successive lines of a text. Typically, line spacing in points is determined as the sum of the then-current font size plus a small spacing factor. For example, for a font size of 18 points, double spacing is typically the result of 2×(18 points+3 points), where 3 points is the spacing factor and “2×” indicates double spacing.

Table 1 presents examples of sets of text formatting criteria that may be used for different reader profiles.

TABLE 1
EXAMPLE TEXT FORMATTING CRITERIA

| | Severe Reading | Moderate Reading | Mild Reading |
|---|---|---|---|
| | Difficulty | Difficulty | Difficulty |
| Early primary | Font size: 26 pt; | Font size: 24 pt; | Font size: 22 pt; |
| grade level | Char scale: 150%; | Char scale: 145%; | Char scale: 140%; |
| | Spacing: Expanded by | Spacing: Expanded by | Spacing: Expanded by |
| | 6.2 points | 5.0 points | 4.5 points |
| Late primary | Font size: 24 pt; | Font size: 22 pt; | Font size: 20 pt; |
| grade level | Char scale: 145%; | Char scale: 140%; | Char scale: 135%; |
| | Spacing: Expanded by | Spacing: Expanded by | Spacing: Expanded by |
| | 5.0 points | 4.5 points | 4.0 points |
| Junior High | Font size: 20 pt; | Font size: 18 pt; | Font size: 16 pt; |
| School | Char scale: 135%; | Char scale: 125%; | Char scale: 100%; |
| or High School | Spacing: Expanded by | Spacing: Expanded by | Spacing: Expanded by |
| grade level | 4.0 points | 3.5 points | 2.5 points |

In Table 1, the designation “Spacing” refers to an expansion of character spacing within words by the indicated amount. Further, all entries in Table 1 typically are used with increased line spacing, such as 1½ line spacing or double spacing. Although the text formatting criteria in Table 1 is known to produce good results in actual readers, embodiments are not limited to the use of the criteria in Table 1. For example, an embodiment that uses character spacing that is expanded by any value from about 2 points to about 7 points will produce improvement in readers of various grade levels and reading ability. Similarly, a font size ranging from about 14 point to about 30 point will produce improvement, and a character scale ranging from 100% to 200% will produce improvement.

The text formatting criteria that is selected in block 104 and shown in Table 1 also may specify a particular type font. The use of a sans-serif font, such as Avant Garde, which is owned by and commercially available for license from International Typeface Corporation, Wilmington, Mass., and its software licensee, Adobe Systems, Inc., San Jose, Calif., has been found to produce good results among readers at a variety of grade levels and with a variety of levels of reading difficulty. Therefore, in one specific embodiment, all the text-formatting criteria as used in block 104 and in Table 1 further specify ITC Avant Garde as the font. Other sans-serif fonts are expected to provide similarly good results.

In block 106, a first text is received. For example, block 106 may involve receiving or reading an electronic document of any format or kind. Examples include, but are not limited to plain text files, HTML documents, Adobe PDF files, Microsoft Word files, etc.

In block 108, the first text is reformatted, based on the selected set of text formatting criteria, to result in creating and storing a second text. Optionally, the second text may be displayed in a computer screen display, printed on a printer, or otherwise used or manipulated.

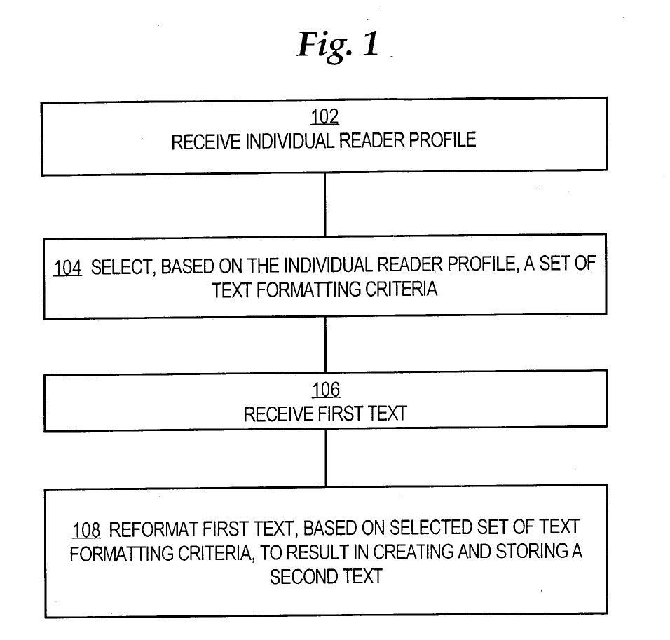

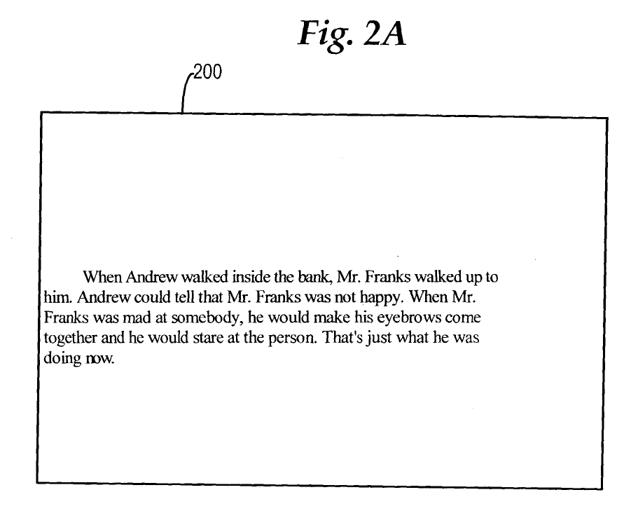

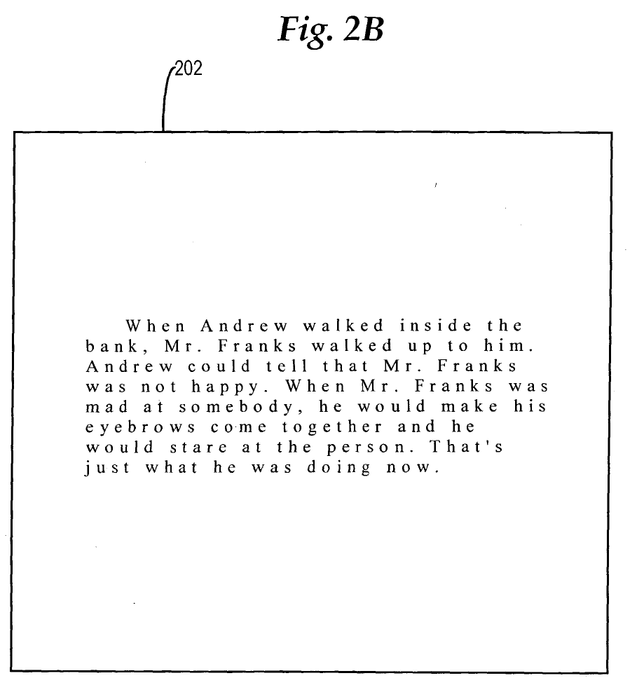

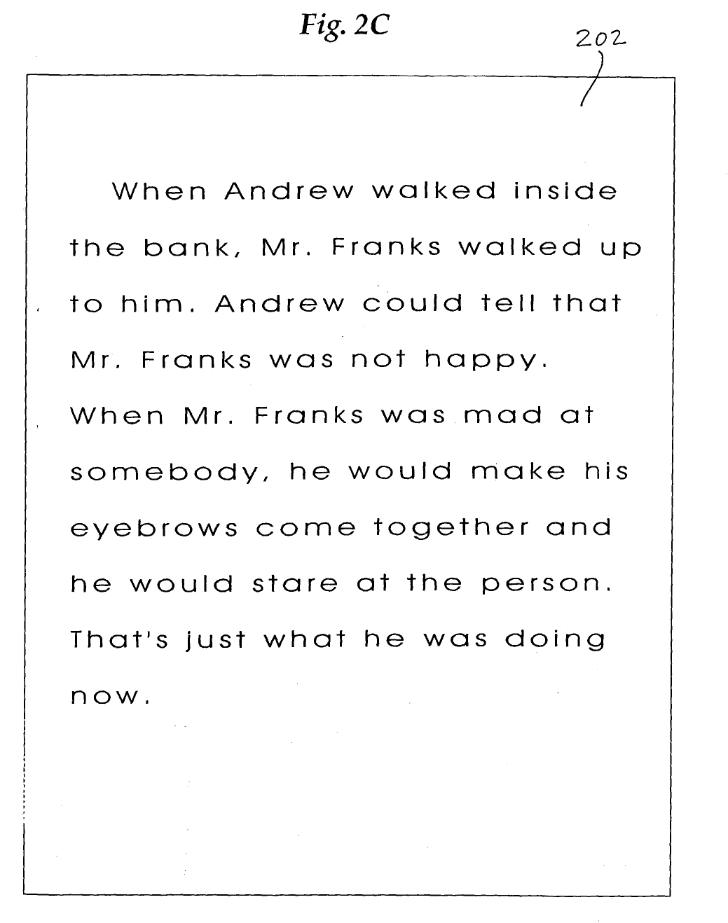

FIG. 2A is a diagram of a first text that may be processed using the method of FIG. 1. The first text 200 is rendered in Times New Roman font of 12-point size, which is a typical text font and size found in many electronic documents and printed matter. However, this font and size have been observed to be associated with reading errors among certain readers. Therefore, methods as described herein may be used to transform first text 200 into a second text that is more readable.

FIG. 2B is a diagram of a second text comprising a copy of the first text in which intra-word character spacing and character scaling are increased. In FIG. 2B, second text 202 has the same content as first text 200, but the character spacing applied to words in the text has been expanded by 4 points. In this context, the terms “character spacing” and “intra-word character spacing” refer to the amount of space between individual characters that form a word, as opposed to spacing between whole words. In certain embodiments, expanding or increasing character spacing may also include expanding or increasing the spacing between whole words.

FIG. 2C is a diagram of a second text comprising a copy of the first text in which intra-word character spacing is increased, character scaling is increased, line spacing is changed, font type is changed, and font size is changed. In FIG. 2C, second text 202 has the same content as first text 200, but the character spacing applied to words in the text has been expanded by 4 points, character scale has been increased to 135%, and font size has been changed to 20 points. This combination of text characteristics has been found to produce improvement, for example, in readers at the Junior High School and High School grade levels that have severe reading difficulty, as indicated in Table 1. This combination of text characteristics may also produce improvement in readers at other grade levels.

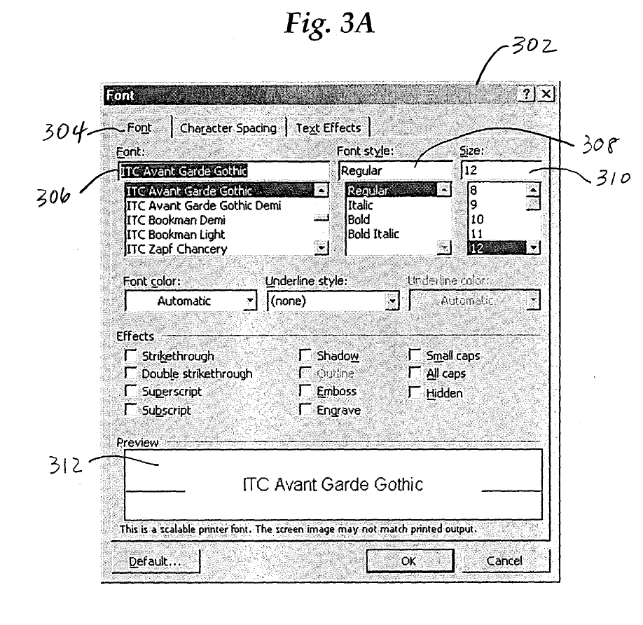

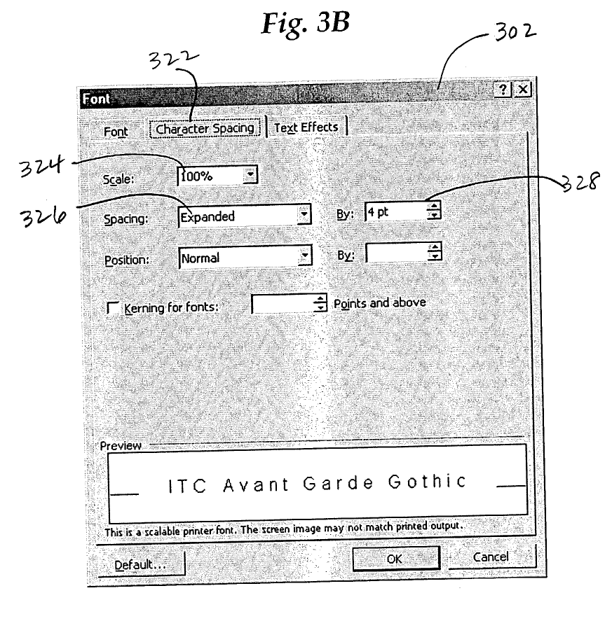

The terms “font” and “character spacing” as used in certain embodiments may be further understood with reference to the use of values for font and character spacing in a software word processing application. FIG. 3A is a diagram of a dialog box for selecting a font in a word processor, and FIG. 3B is a diagram of a dialog box for selecting character spacing. Referring first to FIG. 3A, a font dialog box 302 of the Microsoft Word application includes a Font tab 304 that presents parameter values and selection options for applying a particular font to an electronic document. By selecting values in the dialog box, a user can apply a selected font, font style, and font size to text in an electronic document.

In the example of FIG. 3A, a user has selected ITC Avant Garde Gothic using a Font menu 306, Regular font style using a Font Style menu 308, and a size of 12 points using Size menu 310. Preview box 312 displays a preview of the appearance of the selected font and associated values. The ITC Avant Garde Gothic font is shown in FIG. 3A only as an example; Avant Garde Book and other sans-serif fonts may be used in implementations of the invention.

Referring now to FIG. 3B, dialog box 302 further includes a Character Spacing tab 322 that enables a user to select character scale using a Scale pull-down menu 324. The pull-down menu 324 provides specified character scale values; the user also may enter any other desired character scale value. The user may select character spacing by selecting an option from a Spacing pull-down menu 326, which includes Expanded, Compressed, and Normal options. If Expanded or Compressed is selected, then the user also selects an expansion or compression factor using a numeric selection widget 328. Any desired value may be entered using widget 328.

Although dialog box 302 of FIG. 3A, FIG. 3B does not directly form a part of a preferred embodiment, the process of FIG. 1 may be implemented, in certain embodiments, in a software application that uses dynamic linked libraries (DLLs) that are provided by Microsoft as part of the Microsoft Word application or Office application suite. The DLLs are called by elements of the software application to perform reformatting of the first text into the second text. The DLLs provide programmatic access to functions that are similar to those described herein with respect to FIG. 3A, FIG. 3B. For example, a server-based software application can call functions of the DLLs to apply a specified font type, font size, character spacing, and other text attributes to a text as part of reformatting the text. The structure and operation of an example software application is described further in the next section.

2.0 Implementation Example

2.1 Text Conversion Tool

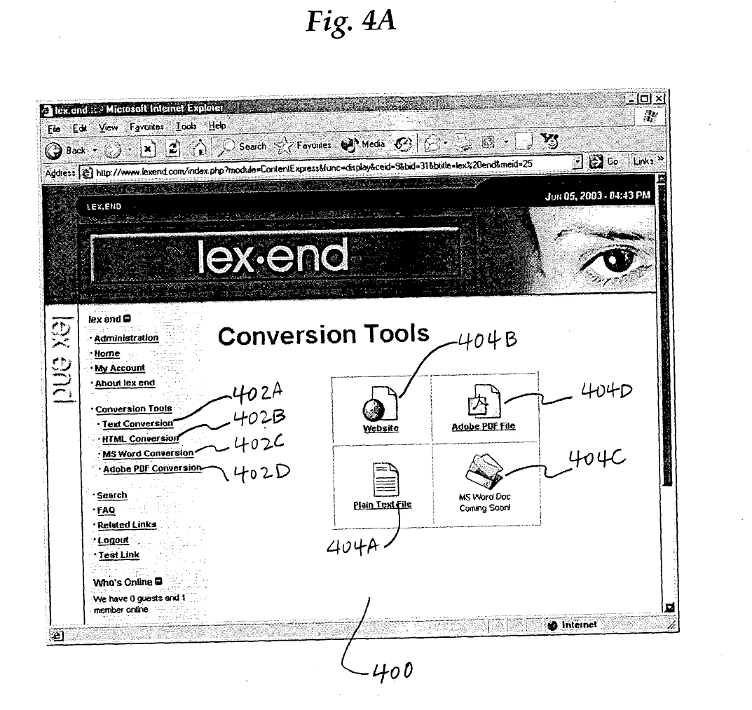

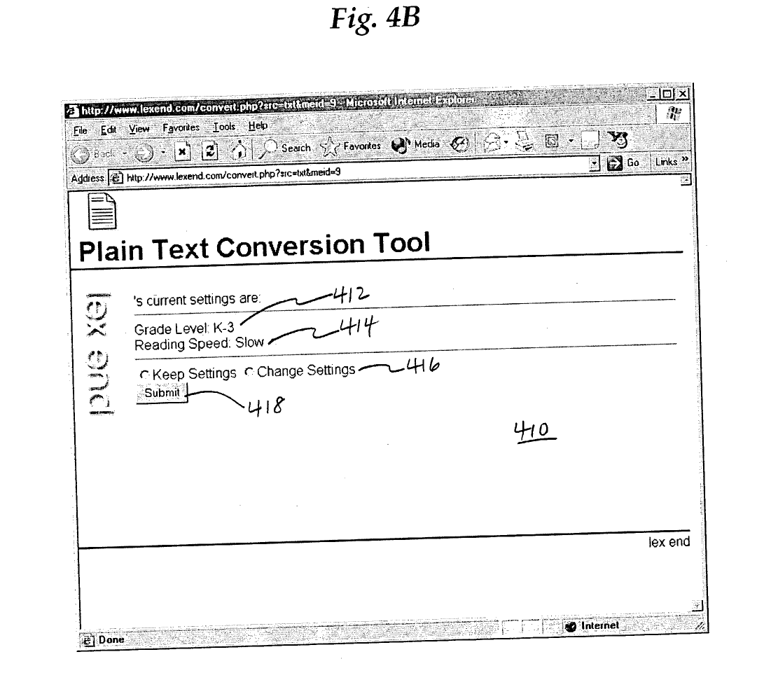

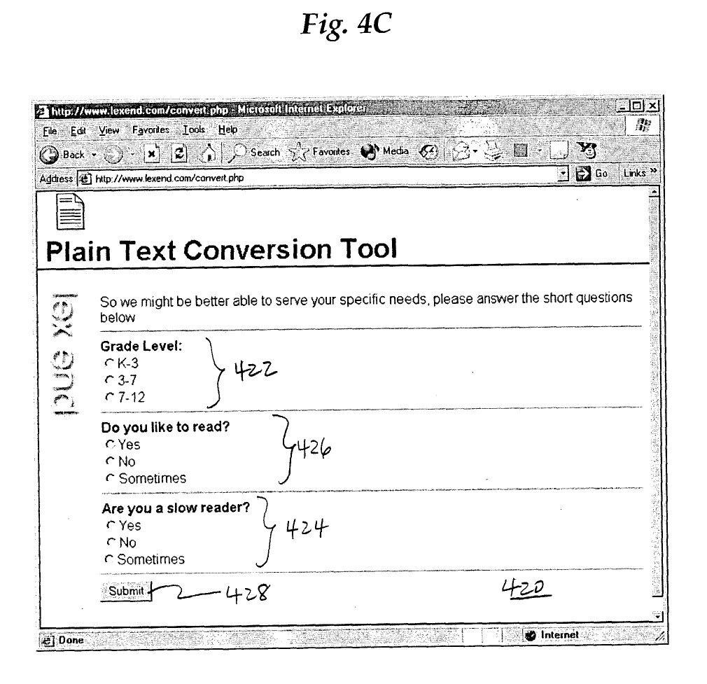

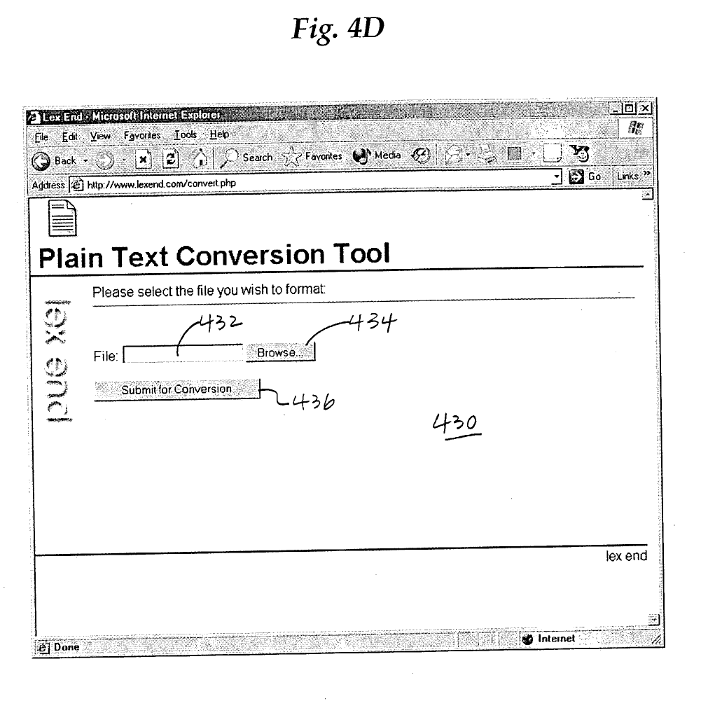

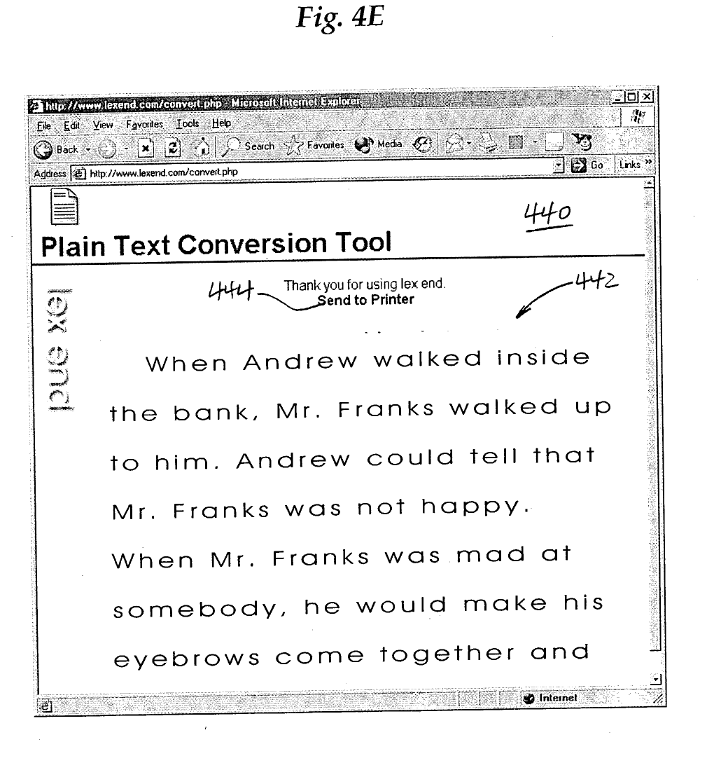

FIG. 4A is a diagram of a screen display for selecting a text conversion tool. In one embodiment, screen display 400 comprises an HTML document that is received from a server-based software application and displayed by a conventional Web browser, in response to a user request to use a text conversion tool. Alternatively, screen display 400 may be generated by a standalone software application that executes at an end-user computer.

Screen display 400 includes a plurality of hyperlinks 402A, 402B, 402C, 402D which, when selected by a user, launch operation of respective text conversion tools. In one embodiment, screen display 400 provides a first hyperlink 402A for accessing a plain text document conversion tool, a second hyperlink 402B for accessing an HTML document conversion tool, a third hyperlink 402C for accessing a Microsoft Word document conversion tool, and a fourth hyperlink 402D for accessing an Adobe PDF document conversion tool. Alternatively, selecting one of graphical icons 404A, 404B, 404C, 404D results in launching the same associated tools.

For purposes of illustrating a clear example, the following description assumes that a user has established a network connection of a conventional Web browser to a server that hosts a text conversion application, requested and received screen display 400, and selected the first graphical icon 404A to launch a plain text conversion tool.

In response, a setting summary page is displayed. FIG. 4B is a diagram of a screen display that is generated upon selecting a plain text conversion tool. Screen display 410 displays a grade level value 412, a reading speed value 414, and includes setting change radio buttons 416 and a Submit button 418. The grade level value 412 and a reading speed value 414 that are initially displayed represent stored default values. The displayed default values may be retained, and used in conversion of a document, by selecting the Keep Settings radio button 416 and selecting the Submit button 418, which signals the host server to use the stored values in later processing of a document.

Alternatively, selecting the Change Settings radio button 416 and selecting the Submit button 418 may change the displayed default values. In response, a question page is displayed. FIG. 4C is a diagram of a screen display of an example question page. The question page 420 comprises grade level radio buttons 422, reading speed radio buttons 424, distraction question radio buttons 426, and a Submit button 428. A user may specify a particular grade level by selecting one of the grade level radio buttons 422. The user may specify whether the user is a slow reader selecting one of the reading speed radio buttons 424. These selections are made effective by subsequently selecting the Submit button 428, which sends the selected values to the host server.

Optionally, a distraction question may be provided. In this context, a distraction question is a question for which the response is not used by the server or software application, but improves the accuracy of user responses to other questions. For example, the distraction question associated with radio buttons 426 is believed to help ensure that the reader provides an accurate response to the reading speed question associated with radio buttons 424.

When the Keep Settings radio button 416 and Submit button 418 of FIG. 4B are selected, or when the Submit button 428 of FIG. 4C is selected, in response, a file selection page is displayed. FIG. 4D is a diagram of an example file selection page. File selection page 430 comprises a file name field 432, a Browse button 434, and a Submit button 436. A user may specify, to the server or software application, a particular stored text file for conversion by entering a file name in file name field 432. Alternatively, the user may select Browse button 434. In response to selecting Browse button 434, on Microsoft Windows systems, a standard file browse and open dialog is displayed, which enables the user to select a file that is located on the user's computer or on an available network server. When a specified file has been selected, the file browse and open dialog closes, and the file name of the selected file is displayed in field 432.

When the Submit button 436 is selected, in response, the server or software application performs several processing steps. In one embodiment, a set of text formatting criteria is selected based on an individual reader profile consisting of the specified grade level value and the specified reading speed value. The criteria may be selected from stored sets of text formatting criteria that are appropriate for readers having different reader profiles. Alternatively, the criteria may be hard-coded into software, so that selection of the criteria involves executing a branch operation within the software, or an equivalent operation.

Further, the specified file is retrieved from a location as indicated by its filename and path. The stored file is expected to comprise an electronic document of the format or kind associated with the then-current conversion tool. Examples include, but are not limited to plain text files, HTML documents, Adobe PDF files, Microsoft Word files, etc.

Then, the text is reformatted, based on the selected set of text formatting criteria, and displayed in a text display page. FIG. 4E is a diagram of an example text display page 440 comprising a second text 442 that has been reformatted based on text formatting criteria that were selected based on the default grade level value and default reading speed value. The text 442 may be read by a reader, or used by another individual. For example, the text 442 may be used in connection with clinical treatment, counseling or evaluation of the reader.

Optionally, text display page 440 may include a print hyperlink 444 which, upon selection by a reader or user, prints the text 442 on a printer that is connected to or accessible by the user computer system.

2.2 Computer Network Arrangement

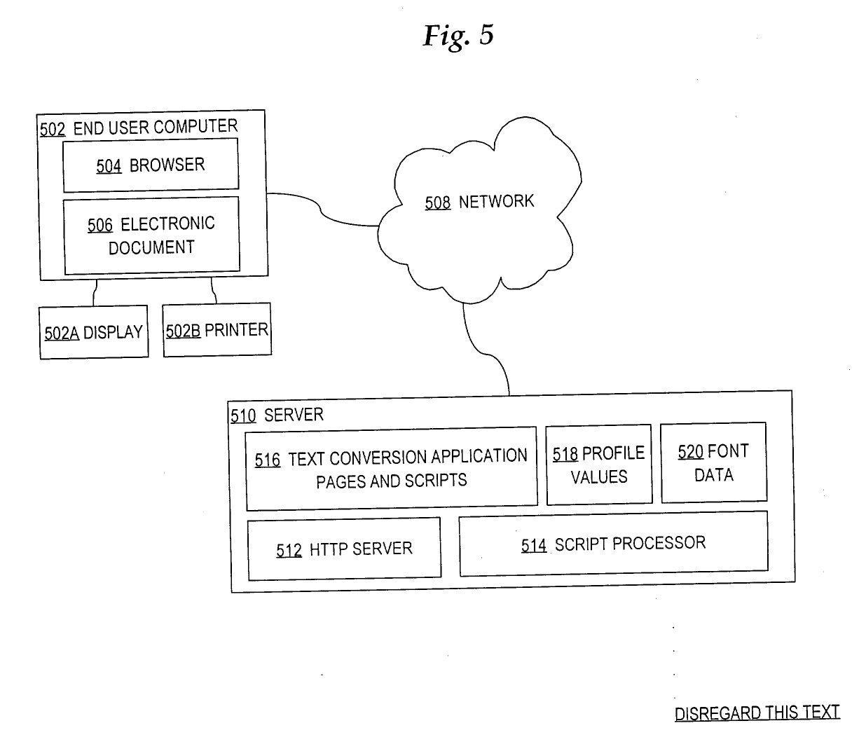

FIG. 5 is a block diagram of a computer network with which an embodiment can be implemented. An end-user computer 502 executes a browser 504 and stores an electronic document 506. The end-user computer may further comprise a display 502A and printer 502B. For purposes of illustrating a clear example, only one electronic document 506 is shown, but in practice there may be any number of electronic documents. Each electronic document 506 corresponds to a first text for purposes of implementing the process of FIG. 1 with the network of FIG. 5.

End-user computer 502 is communicatively coupled to network 508, and can communicate with a server 510 using standard network communication protocols and techniques. For example, network 508 may comprise a LAN, WAN, or internetwork such as the public Internet. In one embodiment, server 510 comprises an HTTP server 512, script processor 514, text conversion application and scripts 516, profile values 518, and font data 520.

The HTTP server 512 may be a conventional Web server, such as the Apache server. The script processor 514 can interpret and execute Web applications that are written in scripting languages such as Perl or CGI. The text conversion application and scripts 516 is a programmatic implementation of the process of FIG. 1, prepared using one or more HTML documents, CGI scripts, Perl scripts, or a combination thereof. The profile values 518 comprise one or more stored parameter values that determine how the text conversion application and scripts 516 performs text conversion. For example, profile values 518 may comprise a grade level value, reading difficulty value, etc. Profile values 518 also may comprise a stored representation of the information in Table 1 above; alternatively, the content of Table 1 may be hard-coded into text conversion application and scripts 516.

Font data 520 comprises a file, driver or other programmatic information that enables text conversion application and scripts 516 to convert or render a first text into a second text with specific font appearance, font size, and character spacing characteristics. For example, font data 520 is the Adobe TrueType font “Avant Garde Book BT,” Version mfgpctt-v1.52, of Bitstream Inc. In other implementations, other sans-serif fonts may be used.

In the embodiment of FIG. 5, text conversion application and scripts 516 performs the functions and generates the pages described herein. Alternatively, equivalent functions may be performed by a software application that executes within end-user computer 502. Further, the same functions may be performed by a software application that executes within a server that is accessible to end-user computer 502 using protocols other than HTML over HTTP. For example, a dedicated client-server system could be developed consisting of a client-side element and a server-side element that communicate over a LAN without using HTML or HTTP. The particular mode of implementation is not critical, and in particular, the implementation of FIG. 4A, FIG. 4B, FIG. 4C, FIG. 4D, FIG. 4E, and FIG. 5 is intended as an example embodiment that does not limit the scope of the claimed invention.

2.3 Example of Computer Hardware and Software Media

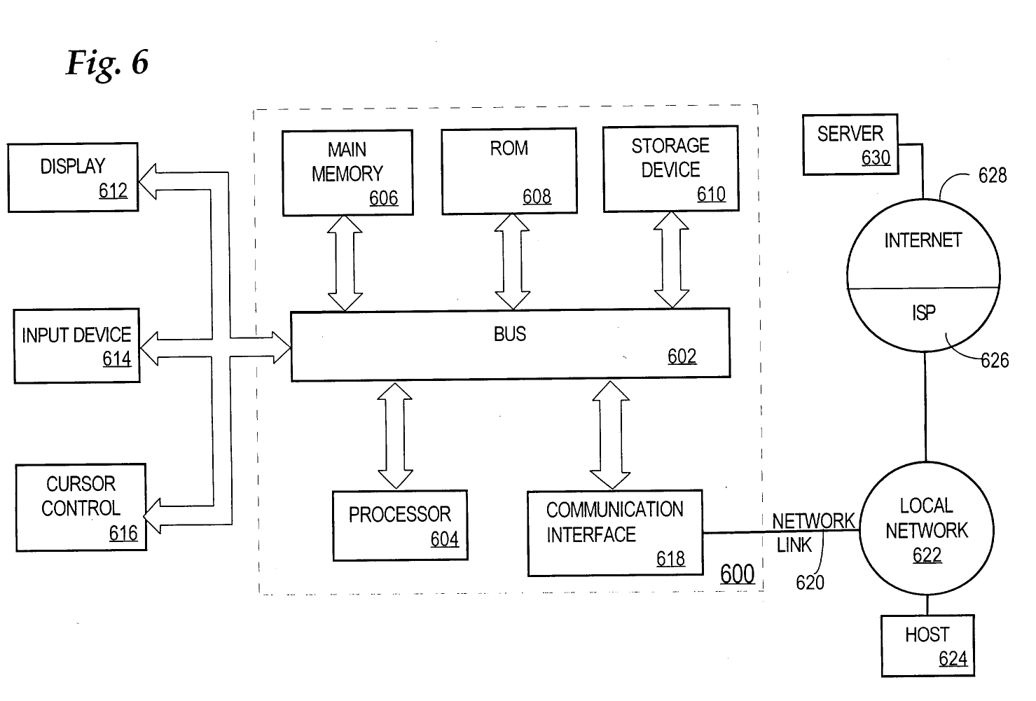

FIG. 6 is a block diagram of a computer system with which an embodiment may be implemented. Computer system 600 includes a bus 602 or other communication mechanism for communicating information, and a processor 604 coupled with bus 602 for processing information. Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

The invention is related to the use of computer system 600 for implementing the techniques described herein. According to one embodiment of the invention, those techniques are performed by computer system 600 in response to processor 604 executing one or more sequences of one or more instructions contained in main memory 606. Such instructions may be read into main memory 606 from another computer-readable medium, such as storage device 610. Execution of the sequences of instructions contained in main memory 606 causes processor 604 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 604 for execution. Such a medium may take many forms, including but not limited to, non-volatile media, volatile media, and transmission media. Non-volatile media includes, for example, optical or magnetic disks, such as storage device 610. Volatile media includes dynamic memory, such as main memory 606. Transmission media includes coaxial cables, copper wire and fiber optics, including the wires that comprise bus 602. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 604 for execution. For example, the instructions may initially be carried on a magnetic disk of a remote computer. The remote computer can load the instructions into its dynamic memory and send the instructions over a telephone line using a modem. A modem local to computer system 600 can receive the data on the telephone line and use an infrared transmitter to convert the data to an infrared signal. An infrared detector can receive the data carried in the infrared signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the worldwide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are exemplary forms of carrier waves transporting the information.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

Processor 604 may execute the received code as it is received, and/or stored in storage device 610, or other non-volatile storage for later execution. In this manner, computer system 600 may obtain application code in the form of a carrier wave.

3.0 Extensions and Alternatives

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method of improving reading of a text, comprising the computer-implemented steps of:
receiving an individual reader profile;
selecting, based on the individual reader profile, a set of text formatting criteria from among a plurality of stored sets of text formatting criteria;
receiving a first text;
reformatting the first text, based on the selected set of text formatting criteria, to result in creating and storing a second text, wherein the reformatting includes expanding spacing of characters within words of the first text.

2. A method as recited in claim 1, wherein the individual profile comprises a grade level value and a reading speed value.

3. A method as recited in claim 1, wherein each of the sets of text formatting criteria comprises a character spacing value.

4. A method as recited in claim 1, wherein each of the sets of text formatting criteria comprises a character spacing value selected from a range of about 2 points expansion to about 7 points expansion.

5. A method as recited in claim 1, wherein each of the sets of text formatting criteria comprises a character spacing value and a font size value.

6. A method as recited in claim 1, wherein each of the sets of text formatting criteria comprises a character spacing value, and a font size value selected from a range of about 14 points to about 30 points.

7. A method as recited in claim 1, wherein each of the sets of text formatting criteria comprises a character spacing value, a font size value, and a line spacing value.

8. A method as recited in claim 1, wherein each of the sets of text formatting criteria comprises a character spacing value, a font size value, a line spacing value, and a character scale value.

9. A method as recited in claim 1, wherein each of the sets of text formatting criteria comprises a character spacing value, a font size value, a line spacing value, and a character scale value selected from a range of about 100% to about 150%.

10. A method as recited in any of claims 2, 3, 4, 5, 6, 7, 8, or 9, wherein each of the sets of text formatting criteria further comprises a font type value that specifies a sans-serif font.

11. A method as recited in any of claims 2, 3, 4, 5, 6, 7, 8, or 9, wherein each of the sets of text formatting criteria further comprises a font type value that specifies Avant Garde font.

12. A method as recited in claim 1, wherein the reformatting step comprises expanding a character spacing characteristic of the first text by a character spacing value specified in the text formatting criteria.

13. A method as recited in claim 1, wherein the reformatting step comprises expanding a character spacing characteristic of the first text by a specified amount selected from a range of about 2 points to about 7 points.

14. A method as recited in claim 1, wherein the reformatting step comprises the steps of expanding a character spacing characteristic of the first text by a specified amount, and changing a font size of the first text to a specified font size.

15. A method as recited in claim 1, wherein the reformatting step comprises the steps of expanding a character spacing characteristic of the first text by a specified amount, and changing a font size of the first text to a specified font size selected from a range of about 14 points to about 30 points.

16. A method as recited in claim 1, wherein the reformatting step comprises the steps of expanding a character spacing characteristic of the first text by a specified amount, changing a font size of the first text to a specified font size, and changing a line spacing of the first text to a specified line spacing.

17. A method as recited in claim 1, wherein the reformatting step comprises the steps of expanding a character spacing characteristic of the first text by a specified amount, changing a font size of the first text to a specified font size, changing a line spacing of the first text to a specified line spacing, and changing a character scale of the first text to a specified character scale.

18. A method as recited in any of claims 12, 13, 14, 15, or 16, wherein the reformatting step further comprises changing a font type of the first text to a sans-serif font.

19. A method as recited in any of claims 12, 13, 14, 15, or 16, wherein the reformatting step further comprises changing a font type of the first text to Avant Garde font.

20. A method of improving reading of a text, comprising the computer-implemented steps of:
receiving an individual profile of a reader;
selecting, based on the individual reader profile, a set of text formatting criteria from among a plurality of stored sets of text formatting criteria;
receiving a first text;
reformatting the first text, based on the selected set of text formatting criteria, to result in creating and storing a second text, including:
expanding a character spacing characteristic of the first text by a specified amount selected from a range of about 2 points to about 7 points;
changing a font size of the first text to a specified font size selected from a range of about 14 points to about 30 points;
changing a font type of the first text to a sans serif font; and
providing the second text to the reader for reading, wherein the reader experiences improved reading of the second text as compared to the first text.

21. A method as recited in claim 20, wherein the individual profile comprises a grade level value and a reading speed value.

22. A method as recited in any of claims 20 or 21, wherein each of the sets of text formatting criteria comprises a character spacing value, a font size value, a line spacing value, and a character scale value.

23. A computer-readable medium carrying one or more sequences of instructions which, when executed by one or more processors, causes the one or more processors to perform the method recited in any one of claims 1-22.

24. A computer system for improving reading of a text, comprising:
means for receiving an individual reader profile;
means for selecting, based on the individual reader profile, a set of text formatting criteria from among a plurality of stored sets of text formatting criteria;
means for receiving a first text; and
means for reformatting the first text, based on the selected set of text formatting criteria, to result in creating and storing a second text, wherein the reformatting includes expanding spacing of characters within words of the first text.

25. An apparatus as recited in claim 24, wherein the individual profile comprises a grade level value and a reading speed value.

26. An apparatus as recited in claim 24, wherein each of the sets of text formatting criteria comprises a character spacing value.

27. An apparatus as recited in claim 24, wherein each of the sets of text formatting criteria comprises a character spacing value selected from a range of about 2 points expansion to about 7 points expansion.

28. An apparatus as recited in claim 24, wherein each of the sets of text formatting criteria comprises a character spacing value and a font size value.

29. An apparatus as recited in claim 24, wherein each of the sets of text formatting criteria comprises a character spacing value, and a font size value selected from a range of about 14 points to about 30 points.

30. An apparatus as recited in claim 24, wherein each of the sets of text formatting criteria comprises a character spacing value, a font size value, and a line spacing value.

31. An apparatus as recited in claim 24, wherein each of the sets of text formatting criteria comprises a character spacing value, a font size value, a line spacing value, and a character scale value.

32. An apparatus as recited in claim 24, wherein each of the sets of text formatting criteria comprises a character spacing value, a font size value, a line spacing value, and a character scale value selected from a range of about 100% to about 150%.

33. An apparatus as recited in any of claims 24, 25, 26, 27, 28, 29, 30, 31, or 32, wherein each of the sets of text formatting criteria further comprises a font type value that specifies a sans-serif font.

34. An apparatus as recited in any of claims 24, 25, 26, 27, 28, 29, 30, 31, or 32, wherein each of the sets of text formatting criteria further comprises a font type value that specifies Avant Garde font.

35. An apparatus as recited in claim 24, wherein the reformatting means comprises means for expanding a character spacing characteristic of the first text by a character spacing value specified in the text formatting criteria.

36. An apparatus as recited in claim 24, wherein the reformatting means comprises means for expanding a character spacing characteristic of the first text by a specified amount selected from a range of about 2 points to about 7 points.

37. An apparatus as recited in claim 24, wherein the reformatting means comprises the means for expanding a character spacing characteristic of the first text by a specified amount, and changing a font size of the first text to a specified font size.

38. An apparatus as recited in claim 24, wherein the reformatting means comprises means for expanding a character spacing characteristic of the first text by a specified amount, and means for changing a font size of the first text to a specified font size selected from a range of about 14 points to about 30 points.

39. An apparatus as recited in claim 24, wherein the reformatting means comprises means for expanding a character spacing characteristic of the first text by a specified amount, means for changing a font size of the first text to a specified font size, and means for changing a line spacing of the first text to a specified line spacing.

40. An apparatus as recited in claim 24, wherein the reformatting means comprises means for expanding a character spacing characteristic of the first text by a specified amount, means for changing a font size of the first text to a specified font size, means for changing a line spacing of the first text to a specified line spacing, and means for changing a character scale of the first text to a specified character scale.

41. An apparatus as recited in any of claims 35, 36, 37, 38, 39, or 40, wherein the reformatting means further comprises means for changing a font type of the first text to a sans-serif font.

42. An apparatus as recited in any of claims 35, 36, 37, 38, 39, or 40, wherein the reformatting step further comprises changing a font type of the first text to Avant Garde font.

43. A computer system for improving reading of a text, comprising:
one or more processors;
a computer-readable medium carrying one or more sequences of instructions which, when executed by one or more processors, causes the one or more processors to perform the method recited in any one of claims 1-22.

44. A written text having improved readability as compared to a source text, comprising a plurality of text characters that are formatted according to a set of text formatting criteria, wherein the reformatting includes expanding spacing of characters within words of the first text.

45. A text as recited in claim 44, wherein each of the sets of text formatting criteria comprises a character spacing value selected from a range of about 2 points expansion to about 7 points expansion.

46. A text as recited in claim 44, wherein each of the sets of text formatting criteria comprises a character spacing value, and a font size value selected from a range of about 14 points to about 30 points.

47. A text as recited in claim 44, wherein each of the sets of text formatting criteria comprises a character spacing value, a font size value, a line spacing value, and a character scale value selected from a range of about 100% to about 150%.

48. A text as recited in any of claims 44, 45, 46, or 47, wherein each of the sets of text formatting criteria further comprises a font type value that specifies a sans-serif font.

49. A text as recited in any of claims 44, 45, 46, or 47, wherein each of the sets of text formatting criteria further comprises a font type value that specifies Avant Garde font.

50. A written text as recited in any of claims 44, 45, 46, or 47, wherein the written text is within a book or other printed paper document.

51. A written text comprising a plurality of text characters having a character spacing value selected from a range of about 2 points expansion to about 7 points expansion, having a font size value selected from a range of about 14 points to about 30 points, and having a character scale value selected from a range of about 100% to about 150%.

52. A text as recited in claim 51, wherein the text characters are in a sans-serif font.

53. A text as recited in claim 51, wherein the text characters are in Avant Garde font.

54. A written text as recited in any of claims 51, 52, or 53, wherein the written text is within a book or other printed paper document.

55. A written text comprising a plurality of text characters having a character spacing value of 6.2 points expansion, a font size of 26 points, a character scale value of 150%, and a sans serif font.

56. A written text comprising a plurality of text characters having a character spacing value of 5.0 points expansion, a font size of 24 points, a character scale value of 145%, and a sans serif font.

57. A written text comprising a plurality of text characters having a character spacing value of 4.5 points expansion, a font size of 22 points, a character scale value of 140%, and a sans serif font.

58. A written text comprising a plurality of text characters having a character spacing value of 4.0 points expansion, a font size of 20 points, a character scale value of 135%, and a sans serif font.

59. A written text comprising a plurality of text characters having a character spacing value of 3.5 points expansion, a font size of 18 points, a character scale value of 125%, and a sans serif font.

60. A written text comprising a plurality of text characters having a character spacing value of 2.5 points expansion, a font size of 16 points, a character scale value of 100%, and a sans serif font.

61. A written text as recited in any of claims 55, 56, 57, 58, 59, or 60, wherein the sans serif font is Avant Garde font.

62. A written text as recited in any of claims 55, 56, 57, 58, 59, or 60, wherein the written text is within a book or other printed paper document.

63. A method as recited in claim 7, wherein each of the sets of text formatting criteria comprises a character spacing value, a font size value, and a line spacing value specifying double spacing.

64. A method as recited in claim 20, wherein reformatting the first text further comprises the step of changing a character scale value of the first text by a specified amount selected from a range of about 100% to about 150%.

65. A method as recited in claim 20, wherein reformatting the first text further comprises the step of changing a line scale value of the first text to double spacing.

66. A method as recited in any of claims 20 or 21, wherein each of the sets of text formatting criteria comprises a character spacing value, a font size value, a font type value, a line spacing value, and a character scale value.
